(19) United States
(12) Patent Application Publication
(10) Pub. No.: US 2014/0002920 A1
(43) Pub. Date: Jan. 2, 2014

(54) Systems and Methods for Identifying Head Contact

(71) Applicants: Ming Jin, Fremont, CA (US); Erich F. Haratsch, Bethlehem, PA (US)

(72) Inventors: Ming Jin, Fremont, CA (US); Erich F. Haratsch, Bethlehem, PA (US)

(73) Assignee: LSI Corporation

(21) Appl. No.: 13/537,487

(22) Filed: Jun. 29, 2012

(51) Int. Cl. G11B 5/40; G11B 20/18; G11B 21/12

(52) U.S. Cl. 360/53; 360/75; G9B/21.021; G9B/20.046; G9B/5.143

(57) ABSTRACT

Various embodiments of the present invention provide systems and methods for determining contact between a head and a storage medium.

### BACKGROUND OF THE INVENTION

The present inventions are related to data storage, and more particularly to systems and methods for detecting contact between a sensor and a storage medium.

A read channel integrated circuit is a component of a magnetic storage device. In operation, a read channel component converts and encodes data to enable a read/write head assembly to write data to a disk and to subsequently read data back. In, for example, a hard disk drive, the disk typically includes many tracks containing encoded data that extend around the disk in a radial pattern. Each track includes one or more user data regions as well as intervening servo data regions. The information of the servo data regions is used to position the read/write head assembly in relation to the disks so that the information stored in the user data regions may be retrieved accurately.

Reading and writing the storage medium is done using the read/write head assembly disposed in relation to the storage medium. At times due either to anomalies on the surface of storage medium, improper placement of the read/write head assembly, or vibration in the storage medium, the read/write head assembly comes into contact with the storage medium. This can result in damage to either the surface of the storage medium and/or to the read/write head assembly. Where the contact is not accurately detected, the same contact may be repeated later and/or data may be written to a damaged area of the storage medium resulting in a potential data loss.

Hence, for at least the aforementioned reasons, there exists a need in the art for advanced systems and methods for determining contact with a storage medium.

### BRIEF SUMMARY OF THE INVENTION

The present inventions are related to data storage, and more particularly to systems and methods for detecting contact between a sensor and a storage medium.

Various embodiments of the present invention provide data storage systems that include a head and a data processor. The head includes a head disk interface sensor operable to provide a contact signal indicating contact between the head and a storage medium disposed in relation to the head. The data processor is operable to: convert the contact signal to a corresponding series of sample values; calculate a standard deviation corresponding to a subset of the series of sample values; and compare one of the series of sample values with a contact threshold to yield an indication of a contact between the storage medium and the head. The contact threshold is related to the standard deviation. In some instances of the aforementioned embodiments, the data processor is further operable to calculate the contact threshold by multiplying the standard deviation by a multiplier value. In some such instances, the multiplier value is greater than one and one half. In one particular case, the multiplier value is two.

In one or more instances of the aforementioned embodiments, the standard deviation is a first standard deviation, the contact threshold is a first contact threshold, the storage medium includes a first region and a second region, wherein the series of sample values is a first series of sample values derived from the contact signal corresponding to the head location over the first region. In such instances, the data processor is further operable to: convert the contact signal to a corresponding second series of sample values when the contact signal corresponds to the head location of the second region; calculate a second standard deviation corresponding to a subset of the second series of sample values; and compare one of the second series of sample values with a second contact threshold to yield the indication of a contact between the storage medium and the head. The second contact threshold is related to the second standard deviation.

Other embodiments of the present invention provide methods for data processing that include: providing a head having a head disk interface sensor; receiving a contact signal from the head disk interface sensor, wherein the contact signal indicates contact between a head and a storage medium; converting the contact signal to a corresponding series of sample values; calculating a standard deviation corresponding to a subset of the series of sample values; and comparing one of the series of sample values with a contact threshold to yield an indication of a contact between the storage medium and the head. The contact threshold is related to the standard deviation.

In some instances of the aforementioned embodiments, the standard deviation is a first standard deviation, the contact threshold is a first contact threshold, the storage medium includes a first region and a second region, and the series of sample values is a first series of sample values derived from the contact signal corresponding to the head location over the first region. In such instances, the methods further include: converting the contact signal to a corresponding second series of sample values when the contact signal corresponds to the head location of the second region; calculating a second standard deviation corresponding to a subset of the second series of sample values; and comparing one of the second series of sample values with a second contact threshold to yield the indication of a contact between the storage medium and the head. The second contact threshold is related to the second standard deviation.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a data processing system including standard deviation based contact detection circuitry in accordance with some embodiments of the present invention;

FIG. 2 is a flow diagram showing a method in accordance with some embodiments of the present invention for contact identification;

FIG. 3 depicts another data processing system including standard deviation based contact detection circuitry in accordance with other embodiments of the present invention;

FIG. 4 is a flow diagram showing another method in accordance with some embodiments of the present invention for contact identification; and

FIG. 5 shows a storage device including a read channel having standard deviation based contact detection circuitry in accordance with one or more embodiments of the present invention.

### DETAILED DESCRIPTION OF THE INVENTION

The present inventions are related to data storage, and more particularly to systems and methods for detecting contact between a sensor and a storage medium.

Various embodiments of the present invention provide systems and methods for determining whether contact has occurred between a head and a storage medium. The head includes a head disk interface and a read head. As used herein, the phrases “head disk interface” or “head disk interface sensor” are used in their broadest sense to mean any sensor that is capable of providing a contact signal indicative of whether contact has occurred with the head in which it is incorporated. Based upon the disclosure provided herein, one of ordinary skill in the art will recognize a variety of head disk interfaces that may be used in relation to embodiments of the present invention. As used herein, the term “head” is used in its broadest sense to mean any assembly including one or more sensors that may be disposed in relation to the storage medium. As an example, a head may be a read head assembly including a read head for sensing previously stored information from the storage medium. Such a read head provides a read signal corresponding to information sensed from the storage medium. As another example, a head may be a read/write head assembly including a write head for writing data to the storage medium and a read head for sensing previously stored information from the storage medium. Based upon the disclosure provided herein, one of ordinary skill in the art will recognize a variety of heads that may be used in relation to different embodiments of the present invention.

In some embodiments, a number of instances of information from the head disk interface to a fly height of a head over a storage medium disk platter is used to calculate a standard deviation, and a contact threshold is calculated as a function of this standard deviation. The standard deviation for each successive instance of the head disk interface information is then calculated, and the calculated standard deviation is compared against the previously calculated contact threshold. Where the standard deviation exceeds the previously calculated threshold, a contact between the head assembly and the storage medium is indicated. In some embodiments, the aforementioned calculations and indication is primarily done in a host, while in other embodiments, it is primarily done in a read channel circuit.

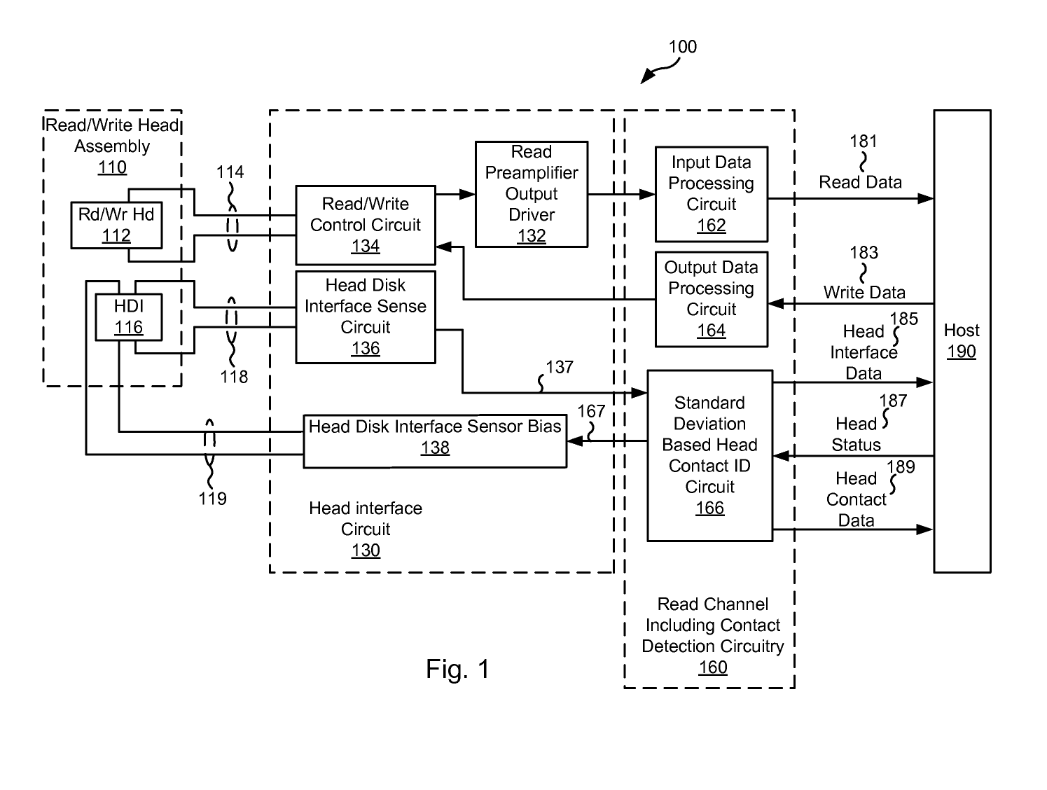

Turning to FIG. 1, a data processing system 100 is shown including standard deviation based contact detection circuitry in accordance with some embodiments of the present invention. The standard deviation based contact detection circuitry is distributed across a read channel circuit 160, a head interface circuit 130, and a host 190. Data processing system 100 includes a read/write head assembly 110. Read/write head assembly 110 includes a head disk interface (HDI) sensor 116 and a read/write head 112.

Head disk interface sensor 116 may be any sensor known in the art that is able to detect the occurrence of contact between read/write head assembly 110 and a storage medium over which it is disposed, and to provide an indication of any detected contact via an electrical signal 118. Such contact may be light contact that results in damage to the storage medium and/or read/write head assembly 110 only after it is repeated multiple times, or heavy contact that are more significant contact events. Such contact events are sometimes referred to as “thermal asperities” due to the significant increase in head temperature when it contacts the storage medium. Head disk interface sensor 116 may be located near a read/write head 112 in the same assembly.

As one example, head disk interface sensor 116 may be modeled as a resistance across which a direct current bias 119 generated by head disk interface sensor bias 138 is applied. If read/write head assembly 110 makes contact with the storage device, kinetic energy is released resulting in an increase in the substrate temperature of head disk interface sensor 116. This increase in temperature causes the resistance of head disk interface sensor 116 to change, thereby changing the voltage drop across head disk interface sensor 116. The change in the resistance of head disk interface sensor 116 may be either an increase or a decrease depending upon the sign of the temperature coefficient of the sensor. Also, it should be noted that the change in resistance may be detected by monitoring either a change in voltage dropped across head disk interface sensor 116 or a change in current through head disk interface sensor 116. Based upon the disclosure provided herein, one of ordinary skill in the art will recognize a variety of head disk interface sensors that may be used in relation to different embodiments of the present invention. For example, a head disk interface sensor 116 utilizing a low bandwidth voltage applied to the resistance and sense the change in voltage or current.

Electrical signal 118 from head disk interface sensor 116 is provided to head disk interface sense circuit 136. Electrical signal 118 includes a current representing the current through head disk interface sensor 118. This current may be amplified by a head disk interface sense circuit 136 to yield a voltage that varies in accordance with the resistance across head disk interface sensor 118. Head disk interface sense circuit 136 may be any amplifier circuitry known in the art capable of receiving an electrical signal from a head disk interface sensor 116 and amplifying it for use by a downstream read channel circuit 160. In one particular embodiment of the present invention, head disk interface sensor circuit 136 includes a low noise amplifier incorporating a high pass filter followed by a programmable gain amplifier. Based upon the disclosure provided herein, one of ordinary skill in the art will recognize other circuits that may be used in relation to different embodiments of the invention to receive and amplify electrical signal 118. Head disk interface sense circuit 136 provides a head disk interface output 137 to a standard deviation based head contact identification circuit 166.

Standard deviation based head contact identification circuit 166 passes a value corresponding to head disk interface output 137 as a head interface data 185 to host 190. Host 190 uses the received head interface data 185 to calculate a head status value 187. Head status value 187 is an indication of whether as head interface data 185 indicated contact between read/write head assembly 110 and a storage medium (not shown). Calculation of head status value 187 may be done using any algorithm known in the art that yields a value indicating contact or no-contact between read/write head assembly 110 and the storage medium. Existing systems and methods for generating head interface data 185 from electrical signal 118 may be used in relation to the various embodiments of the present invention. Where no contact is registered between read/write head assembly 110 and the storage medium, host 190 provides head status value 187 that exhibits a discernably low value when compared to the value of head status value 187 when a contact is registered between read/write head assembly 110 and the storage medium.

Standard deviation based head contact identification circuit 166 calculates a no-contact standard deviation based upon a number of instances of head status value 187 that do not indicate contact between read/write head assembly 110 and the storage medium. Once enough instances of head status value 187 have been received, no-contact standard deviation based head contact identification circuit 166 calculates a contact threshold as a function of the calculated no-contact standard deviation. In one particular embodiment of the present invention, at least ten instances of head status value 187 that do not indicate contact between read/write head assembly 110 and the storage medium are required before a no-contact standard deviation is calculated. Based upon the disclosure provided herein, one of ordinary skill in the art will recognize other numbers of instances of head status value 187 that may be used to calculate the no-contact standard deviation. In one particular embodiment of the present invention, the contact threshold is twice the no-contact standard deviation. In other embodiments of the present invention, the contact threshold is three times the no-contact standard deviation. In yet other embodiments of the present invention, the contact threshold is one and one half times the no-contact standard deviation. In some cases, the multiplier by which the standard deviation is multiplied is calibrated based upon statistics gathered from a number of different regions of the medium. In some cases, the multiplier may be different for each region. In other cases, the multiplier is the same for all regions of the device.

In some embodiments of the present invention, different no-contact standard deviations are calculated for different regions on the storage medium. For example, a no-contact standard deviation is calculated for an outer diameter region of the storage medium, another no-contact standard deviation is calculated for an inner diameter region of the storage medium, and another no-contact standard deviation is calculated for a medium diameter region of the storage medium. Based upon the disclosure provided herein, one of ordinary skill in the art will recognize a variety of regions of the storage medium over which distinct no-contact standard deviations. A respective contact threshold is calculated for each of the distinct no-contact standard deviations, and the respective contact thresholds are used when read/write head assembly 110 is disposed over that particular region of the storage medium.

As each instance of head status value 187 is received from host 190, head status value 187 is compared with the contact threshold for the region of the storage medium over which read/write head assembly 110 is disposed. Where head status value 187 exceeds the respective calculated contact threshold for the region of the storage medium over which read/write head assembly 110 is disposed, standard deviation based head contact identification circuit 166 asserts a head contact data signal 189 that indicates to host 190 that a contact between read/write head assembly 110 and the storage medium was detected. Otherwise, head contact data signal 189 is de-asserted indicating that no contact occurred.

Where contact occurs as indicated by assertion of head contact data signal 189, host 190 may map out that particular region of the storage medium because of the possibility that the storage medium at that location has been damaged. Alternatively, or in addition, standard deviation based head contact identification circuit 166 provides an increase signal 167 to a head disk interface sensor bias 138 causing head disk interface sensor bias 138 to adjust direct current bias 119 to modify the fly height of read/write head assembly 110 over the storage medium.

Read/write head 112 writes data corresponding to a data signal 114 to the storage medium or sense data stored on the storage medium and provides the sensed data as data signal 114. Data signal 114 is either provided by a read/write control circuit 134 or received by read/write control circuit 134. Where a data write is requested by host 190, host 190 provides write data 183 to an output processing circuit 164. Output processing circuit 164 encodes write data 183 into codewords. The codewords are provided to read/write control circuit 134. Read/write control circuit 134 converts the codewords to a series of current levels provided as data signal 114 to read/write head 112. The current causes read/write head 112 to magnetize the storage medium corresponding to the current.

Alternatively, where a data read is requested by host 190, read/write head assembly 110 senses magnetic information stored on the storage medium and provides a current as data signal 114. In turn, data signal 114 is provided to read/write control circuit 134 that converts the received current to voltage levels that are provided to a read preamplifier output driver 132. Read preamplifier output driver 132 amplifies the voltage values and provides the amplified analog signal to an input data processing circuit 162. Input data processing circuit 162 applies a data processing algorithm to the received data to recover the originally written data set. The originally written data set is provided as read data 181 to host 190. In some embodiments of the present invention, the data processing algorithm includes a data detection algorithm and a data decode algorithm. The data detection algorithm may be a maximum a posteriori data detection algorithm, and the data decode algorithm may be a low density parity check algorithm. Based upon the disclosure provided herein, one of ordinary skill in the art will recognize a variety of data processing algorithms that may be implemented by input data processing circuit 162.

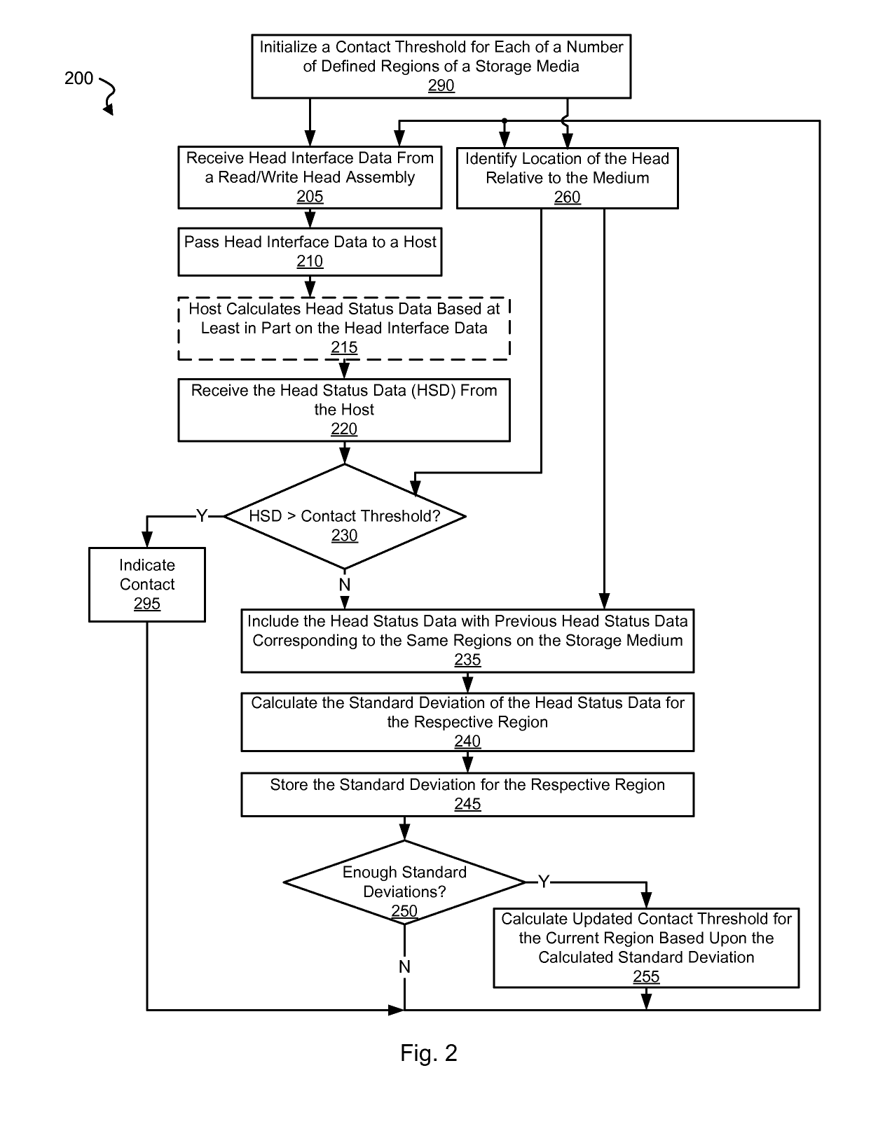

Turning to FIG. 2, a flow diagram 200 shows a method in accordance with some embodiments of the present invention for contact identification. Following flow diagram 200, a contact threshold for each of a number of defined regions on a storage medium are initialized (block 290). This initialization programs a number of contact thresholds with default values that when exceeded may indicate contact between a read/write head assembly and a storage medium. Head interface data is received from a read/write head assembly (block 205). The head interface data varies depending upon contact. In particular, when contact occurs between the read/write head assembly and the storage medium, the head interface data exhibits a discernably low value when compared to the value when a contact is registered between the read/write head assembly and the storage medium. In addition, the location of the read/write head assembly relative to the storage medium is identified (block 260).

The head interface data is provided to a host (block 210). In turn, the host calculates head status data corresponding to the received head interface data (block 215). Where no contact is registered between a read/write head assembly and a storage medium, the head interface data exhibits a discernably low value when compared to the value when a contact is registered between the read/write head assembly and the storage medium. The head status data follows this where a contact is indicated by a discernably higher value when compared to a no-contact situation. The head status data is provided from the host (block 220), and is compared against a contact threshold corresponding to the region of the storage medium over which the read/write head assembly is disposed (i.e., the location identified in block 260) (block 230). At the outset, the contact threshold is the value at which it was initialized in block 290, and later it is the value at which it is updated as described below in relation to block 255.

Where the received head status data exceeded the contact threshold (block 230), a contact is indicated (block 295). Otherwise, where the received head status data did not exceed the contact threshold (block 230), the received head status data is included with previous instances of the head status data corresponding to the same region on the storage medium (block 235). This results in a number of instances of head interface data for each of a number of regions on the storage medium. Using data from a respective region, a no-contact standard deviation of the head status data for the particular region is calculated (block 240). Such a standard deviation may be calculated using any approach known in the art for calculating a standard deviation. The calculated no-contact standard deviation is stored for the respective region to which it pertains (block 245). It is determined whether enough samples of head status data have been received to yield a reliable standard deviation (block 250). In some embodiments of the present invention, at least ten samples of the head status data are required before a no-contact standard deviation is considered reliable. Where sufficient samples of the head status data have been received (block 250), an updated contact threshold is calculated as a function of the no-contact standard deviation (block 255). In one particular embodiment of the present invention, the contact threshold is twice the no-contact standard deviation. In other embodiments of the present invention, the contact threshold is three times the no-contact standard deviation. In yet other embodiments of the present invention, the contact threshold is one and one half times the no-contact standard deviation. A contact threshold is calculated for each of the defined regions on the storage medium using the no-contact standard deviation corresponding to the region. The processes are then repeated using the updated contact threshold for the region.

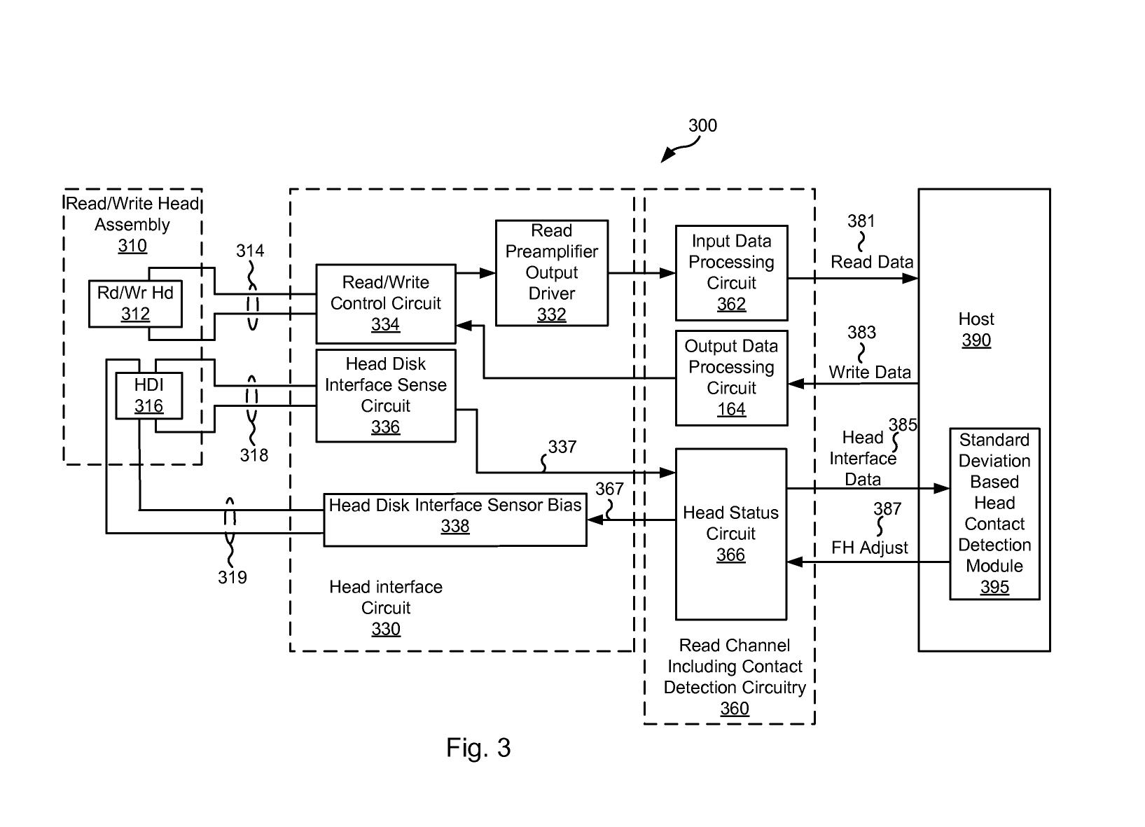

Turning to FIG. 3, another data processing system 300 is shown including standard deviation based contact detection circuitry in accordance with other embodiments of the present invention. The standard deviation based contact detection circuitry is distributed across a read channel circuit 360, a head interface circuit 330, and a host 390. Data processing system 300 includes a read/write head assembly 310. Read/write head assembly 310 includes a head disk interface (HDI) sensor 316 and a read/write head 312.

Head disk interface sensor 316 may be any sensor known in the art that is able to detect the occurrence of contact between read/write head assembly 310 and a storage medium over which it is disposed, and to provide an indication of any detected contact via an electrical signal 318. Such contact may be light contact that results in damage to the storage medium and/or read/write head assembly 310 only after it is repeated multiple times, or heavy contact that are more significant contact events. Such contact events are sometimes referred to as “thermal asperities” due to the significant increase in head temperature when it contacts the storage medium. Head disk interface sensor 316 may be located near a read/write head 312 in the same assembly.

As one example, head disk interface sensor 316 may be modeled as a resistance across which a direct current bias 319 generated by head disk interface sensor bias 338 is applied. If read/write head assembly 310 makes contact with the storage device, kinetic energy is released resulting in an increase in the substrate temperature of head disk interface sensor 316. This increase in temperature causes the resistance of head disk interface sensor 316 to change, thereby changing the voltage drop across head disk interface sensor 316. The change in the resistance of head disk interface sensor 316 may be either an increase or a decrease depending upon the sign of the temperature coefficient of the sensor. Also, it should be noted that the change in resistance may be detected by monitoring either a change in voltage dropped across head disk interface sensor 316 or a change in current through head disk interface sensor 316. Based upon the disclosure provided herein, one of ordinary skill in the art will recognize a variety of head disk interface sensors that may be used in relation to different embodiments of the present invention. For example, a head disk interface sensor 316 utilizing a low bandwidth voltage applied to the resistance and sense the change in voltage or current.

Electrical signal 318 from head disk interface sensor 316 is provided to head disk interface sense circuit 336. Electrical signal 318 includes a current representing the current through head disk interface sensor 318. This current may be amplified by a head disk interface sense circuit 336 to yield a voltage that varies in accordance with the resistance across head disk interface sensor 318. Head disk interface sense circuit 336 may be any amplifier circuitry known in the art capable of receiving an electrical signal from a head disk interface sensor 316 and amplifying it for use by a downstream read channel circuit 360. In one particular embodiment of the present invention, head disk interface sensor circuit 336 includes a low noise amplifier incorporating a high pass filter followed by a programmable gain amplifier. Based upon the disclosure provided herein, one of ordinary skill in the art will recognize other circuits that may be used in relation to different embodiments of the invention to receive and amplify electrical signal 318. Head disk interface sense circuit 336 provides a head disk interface output 337 to a head status circuit 366 that digitizes (i.e., applies an analog to digital conversion) to the head disk interface output 337. In turn, head status circuit 366 provides the series of digital samples from the digitization as a head interface data output 385 to a standard deviation based head contact detection module 395 included in host 390.

Where no contact is registered between read/write head assembly 310 and the storage medium, head interface data output 385 exhibits a discernably low value when compared to the value when a contact is registered between read/write head assembly 310 and the storage medium. Standard deviation based head contact detection module 395 calculates a no-contact standard deviation based upon a number of instances of head interface data output 385 that do not indicate contact between read/write head assembly 310 and the storage medium. Once enough instances of head interface data output 385 have been received, standard deviation based head contact detection module 395 calculates a contact threshold as a function of the calculated no-contact standard deviation. In one particular embodiment of the present invention, at least ten instances of head interface data output 385 that do not indicate contact between read/write head assembly 310 and the storage medium are required before a no-contact standard deviation is calculated. Based upon the disclosure provided herein, one of ordinary skill in the art will recognize other numbers of instances of head interface data output 385 that may be used to calculate the no-contact standard deviation. In one particular embodiment of the present invention, the contact threshold is twice the no-contact standard deviation. In other embodiments of the present invention, the contact threshold is three times the no-contact standard deviation. In yet other embodiments of the present invention, the contact threshold is one and one half times the no-contact standard deviation.

In some embodiments of the present invention, different no-contact standard deviations are calculated for different regions on the storage medium. For example, a no-contact standard deviation is calculated for an outer diameter region of the storage medium, another no-contact standard deviation is calculated for an inner diameter region of the storage medium, and another no-contact standard deviation is calculated for a medium diameter region of the storage medium. Based upon the disclosure provided herein, one of ordinary skill in the art will recognize a variety of regions of the storage medium over which distinct no-contact standard deviations. A respective contact threshold is calculated for each of the distinct no-contact standard deviations, and the respective contact thresholds are used when read/write head assembly 310 is disposed over that particular region of the storage medium.

As each instance of head interface data output 385 is received, head interface data output 385 is compared with the contact threshold for the region of the storage medium over which read/write head assembly 310 is disposed. Where head interface data output 385 exceeds the respective calculated contact threshold for the region of the storage medium over which read/write head assembly 310 is disposed, standard deviation based head contact detection module 395 indicates contact at the current location over which read/write head assembly 310 is disposed.

Where contact is indicated, host 390 may map out that particular region of the storage medium because of the possibility that the storage medium at that location has been damaged. Alternatively, or in addition, standard deviation based head contact detection module 395 provides a fly height adjustment signal 387 to head status circuit 366. In turn, head status circuit 366 provides an increase signal 367 to a head disk interface sensor bias 338 causing head disk interface sensor bias 338 to adjust direct current bias 319 to modify the fly height of read/write head assembly 310 over the storage medium.

Read/write head 312 writes data corresponding to a data signal 314 to the storage medium or sense data stored on the storage medium and provides the sensed data as data signal 314. Data signal 314 is either provided by a read/write control circuit 334 or received by read/write control circuit 334. Where a data write is requested by host 390, host 390 provides write data 383 to an output processing circuit 364. Output processing circuit 364 encodes write data 383 into codewords. The codewords are provided to read/write control circuit 334. Read/write control circuit 334 converts the codewords to a series of current levels provided as data signal 314 to read/write head 312. The current causes read/write head 312 to magnetize the storage medium corresponding to the current.

Alternatively, where a data read is requested by host 390, read/write head assembly 310 senses magnetic information stored on the storage medium and provides a current as data signal 314. In turn, data signal 314 is provided to read/write control circuit 334 that converts the received current to voltage levels that are provided to a read preamplifier output driver 332. Read preamplifier output driver 332 amplifies the voltage values and provides the amplified analog signal to an input data processing circuit 362. Input data processing circuit 362 applies a data processing algorithm to the received data to recover the originally written data set. The originally written data set is provided as read data 381 to host 390. In some embodiments of the present invention, the data processing algorithm includes a data detection algorithm and a data decode algorithm. The data detection algorithm may be a maximum a posteriori data detection algorithm, and the data decode algorithm may be a low density parity check algorithm. Based upon the disclosure provided herein, one of ordinary skill in the art will recognize a variety of data processing algorithms that may be implemented by input data processing circuit 362.

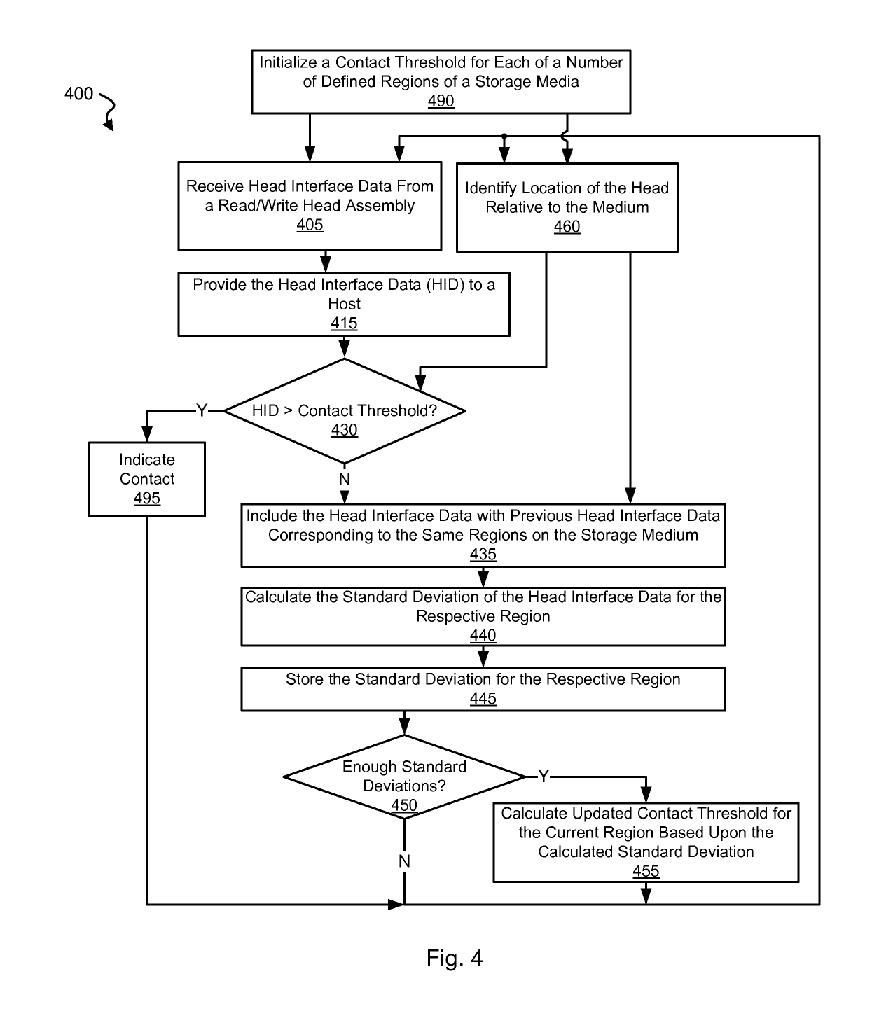

Turning to FIG. 4, a flow diagram 400 shows another method in accordance with some embodiments of the present invention for contact identification. Following flow diagram 400, a contact threshold for each of a number of defined regions on a storage medium are initialized (block 490). This initialization programs a number of contact thresholds with default values that when exceeded may indicate contact between a read/write head assembly and a storage medium. Head interface data is received from a read/write head assembly (block 405). The head interface data varies depending upon contact. In particular, when contact occurs between the read/write head assembly and the storage medium, the head interface data exhibits a discernably low value when compared to the value when a contact is registered between the read/write head assembly and the storage medium. In addition, the location of the read/write head assembly relative to the storage medium is identified (block 460).

The head interface data is provided to a host (block 415). In turn, the host determines whether the received head interface data exceeded the contact threshold for the region of the storage medium over which the read/write head assembly is disposed (i.e., the location identified in block 460) (block 430). Where the received head interface data exceeded the contact threshold (block 430), a contact is indicated (block 495). Otherwise, where the received head interface data did not exceed the contact threshold (block 430), the received head interface data is included with previous instances of the head interface data corresponding to the same region on the storage medium (block 435). This results in a number of instances of head interface data for each of a number of regions on the storage medium. Using data from a respective region, a no-contact standard deviation of the head interface data for the particular region is calculated (block 440). Such a standard deviation may be calculated using any approach known in the art for calculating a standard deviation. The calculated no-contact standard deviation is stored for the respective region to which it pertains (block 445). It is determined whether enough samples of head interface data have been received to yield a reliable standard deviation (block 450). In some embodiments of the present invention, at least ten samples of the head interface data are required before a no-contact standard deviation is considered reliable. Where sufficient samples of the head interface data have been received (block 450), an updated contact threshold is calculated as a function of the no-contact standard deviation (block 455). In one particular embodiment of the present invention, the contact threshold is twice the no-contact standard deviation. In other embodiments of the present invention, the contact threshold is three times the no-contact standard deviation. In yet other embodiments of the present invention, the contact threshold is one and one half times the no-contact standard deviation. A contact threshold is calculated for each of the defined regions on the storage medium using the no-contact standard deviation corresponding to the region. The processes are then repeated using the updated contact threshold for the region.

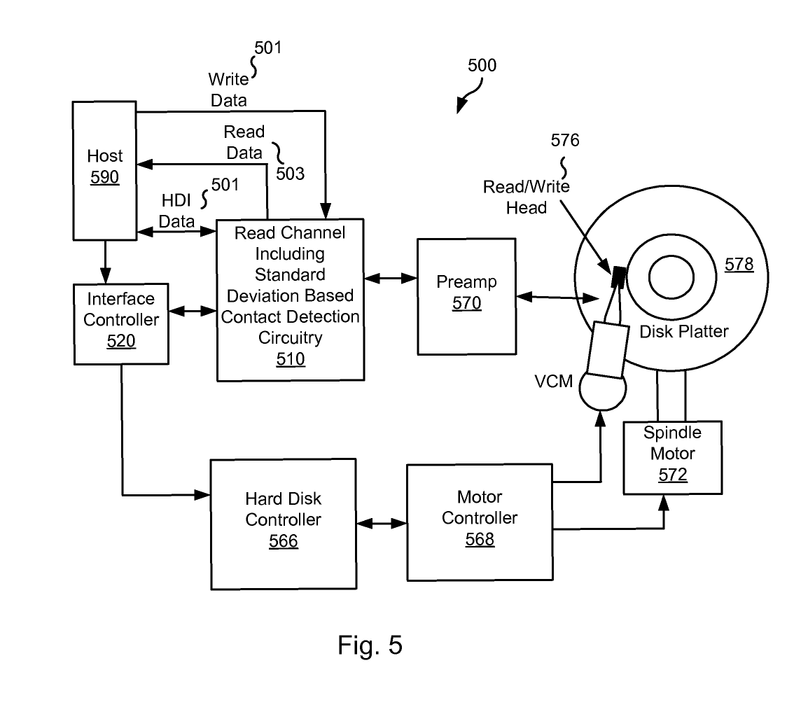

Turning to FIG. 5, a storage system 500 including a read channel circuit 510 having standard deviation based contact detection circuitry is shown in accordance with some embodiments of the present invention. Storage system 500 may be, for example, a hard disk drive. Storage system 500 also includes a preamplifier 570, an interface controller 520, a hard disk controller 566, a motor controller 568, a spindle motor 572, a disk platter 578, and a read/write head assembly 576. A host 590 is responsible for providing read and write commands to storage system 500 via interface controller 520, and read channel circuit 510. Interface controller 520 controls addressing and timing of data to/from disk platter 578 in accordance with commands received from host 590. The data on disk platter 578 consists of groups of magnetic signals that may be detected by read/write head assembly 576 when the assembly is properly positioned over disk platter 578. In one embodiment, disk platter 578 includes magnetic signals recorded in accordance with either a longitudinal or a perpendicular recording scheme.

In a typical read operation, read/write head assembly 576 is accurately positioned by motor controller 568 over a desired data track on disk platter 578. Motor controller 568 both positions read/write head assembly 576 in relation to disk platter 578 and drives spindle motor 572 by moving read/write head assembly to the proper data track on disk platter 578 under the direction of hard disk controller 566. Spindle motor 572 spins disk platter 578 at a determined spin rate (RPMs). Once read/write head assembly 578 is positioned adjacent the proper data track, magnetic signals representing data on disk platter 578 are sensed by read/write head assembly 576 as disk platter 578 is rotated by spindle motor 572. The sensed magnetic signals are provided as a continuous, minute analog signal representative of the magnetic data on disk platter 578. This minute analog signal is transferred from read/write head assembly 576 to read channel circuit 510 via preamplifier 570. Preamplifier 570 is operable to amplify the minute analog signals accessed from disk platter 578. In turn, read channel circuit 510 decodes and digitizes the received analog signal to recreate the information originally written to disk platter 578. This data is provided as read data 503 to a receiving circuit. A write operation is substantially the opposite of the preceding read operation with write data 501 being provided to read channel circuit 510. This data is then encoded and written to disk platter 578.

During operation, a number of instances of head disk interface information corresponding to a fly height of read/write head 576 over disk platter 578 is used to calculate a standard deviation, and a contact threshold is calculated as a function of the standard deviation. The standard deviation for each successive instance of the head disk interface information is calculated, and the calculated standard deviation is compared against the previously calculated threshold. Where it exceeds the previously calculated threshold, a contact between read/write head assembly 576 and disk platter 578. In some embodiments, the processing is primarily done in host 590, while in other embodiments, the processing is primarily done in the read channel circuit 510. In some embodiments, the processing is done similar to that discussed above in relation to FIG. 1 or to that discussed above in relation to FIG. 3. In various cases, the process may be performed similar to that discussed above in relation to FIG. 2, or similar to that discussed above in relation to FIG. 4.

It should be noted that storage system 500 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 500, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

A data decoder circuit used in relation to read channel circuit 510 may be, but is not limited to, a low density parity check (LDPC) decoder circuit as are known in the art. Such low density parity check technology is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data storage system, the system comprising:
a head including a head disk interface sensor operable to provide a contact signal indicating contact between the head and a storage medium disposed in relation to the head; and
a data processor operable to:
convert the contact signal to a corresponding series of sample values;
calculate a standard deviation corresponding to a subset of the series of sample values; and
compare one of the series of sample values with a contact threshold to yield an indication of a contact between the storage medium and the head, wherein the contact threshold is related to the standard deviation.

2. The data storage system of claim 1, wherein the data processor is further operable to:
calculate the contact threshold by multiplying the standard deviation by a multiplier value.

3. The data storage system of claim 2, wherein the multiplier value is greater than one and one half.

4. The data storage system of claim 3, wherein the multiplier value is two.

5. The data storage system of claim 1, wherein the standard deviation is a first standard deviation, wherein the contact threshold is a first contact threshold, wherein the storage medium includes a first region and a second region, wherein the series of sample values is a first series of sample values derived from the contact signal corresponding to the head location over the first region, and wherein the data processor is further operable to:
convert the contact signal to a corresponding second series of sample values when the contact signal corresponds to the head location of the second region;
calculate a second standard deviation corresponding to a subset of the second series of sample values; and
compare one of the second series of sample values with a second contact threshold to yield the indication of a contact between the storage medium and the head, wherein the second contact threshold is related to the second standard deviation.

6. The data storage system of claim 5, wherein the data processor is further operable to:
calculate the second contact threshold by multiplying the second standard deviation by a multiplier value.

7. The data storage system of claim 6, wherein the multiplier value is greater than one and one half.

8. The data storage system of claim 1, wherein the head further includes a read/write head operable to sense information maintained on the storage medium and to provide a read signal corresponding to the sensed information.

9. The data storage system of claim 8, wherein the data processor is further operable to process the read signal to derive data originally directed toward the storage medium.

10. The data storage system of claim 9, wherein the data processor includes a data detector circuit and a data decoder circuit.

11. The data storage system of claim 10, wherein the data decoder circuit is a low density parity check decoder circuit.

12. A method for data processing, the method comprising:
providing a head having a head disk interface sensor;
receiving a contact signal from the head disk interface sensor, wherein the contact signal indicates contact between a head and a storage medium;
converting the contact signal to a corresponding series of sample values;
calculating a standard deviation corresponding to a subset of the series of sample values; and
comparing one of the series of sample values with a contact threshold to yield an indication of a contact between the storage medium and the head, wherein the contact threshold is related to the standard deviation.

13. The method of claim 12, wherein the method further comprises:
calculating the contact threshold by multiplying the standard deviation by a multiplier value.

14. The method of claim 13, wherein the multiplier value is greater than one and one half.

15. The method of claim 12, wherein the standard deviation is a first standard deviation, wherein the contact threshold is a first contact threshold, wherein the storage medium includes a first region and a second region, wherein the series of sample values is a first series of sample values derived from the contact signal corresponding to the head location over the first region, and wherein the method further comprises:
converting the contact signal to a corresponding second series of sample values when the contact signal corresponds to the head location of the second region;
calculating a second standard deviation corresponding to a subset of the second series of sample values; and
comparing one of the second series of sample values with a second contact threshold to yield the indication of a contact between the storage medium and the head, wherein the second contact threshold is related to the second standard deviation.

16. The method of claim 15, wherein the method further comprises:
calculating the second contact threshold by multiplying the second standard deviation by a multiplier value.

17. The method of claim 16, wherein the multiplier value is greater than one and one half.

18. The method of claim 12, wherein the method further comprises:
initializing the contact threshold; and
subsequently updating the contact threshold to be a the standard deviation multiplied by a multiplier value.

19. A contact indication circuit, the circuit comprising:
a head including:
a head disk interface sensor operable to provide a contact signal indicating contact between the head and a storage medium disposed in relation to the head; and
a read/write head operable to sense information maintained on the storage medium and to provided a read signal corresponding to the sensed information; and
a processing circuit operable to:
convert the contact signal to a corresponding series of sample values;
calculate a standard deviation corresponding to a subset of the series of sample values; and
compare one of the series of sample values with a contact threshold to yield an indication of a contact between the storage medium and the head, wherein the contact threshold is the standard deviation multiplied by a multiplier value.

20. The circuit of claim 19, wherein the multiplier value is greater than one and one half.
